(19) United States
(12) Patent Application Publication
(10) Pub. No.: US 2026/0249216 A1
(43) Pub. Date: Aug. 27, 2026

(54) FILTER DEVICE AND FILTER ASSEMBLY

(71) Applicant: LG Electronics Inc., Seoul (KR)

(72) Inventors: Hyunwoo SEO, Seoul (KR); O Min KWON, Seoul (KR); Dongchul JIN, Seoul (KR)

(73) Assignee: LG Electronics Inc., Seoul (KR)

(21) Appl. No.: 19/394,679

(22) Filed: Nov. 19, 2025

(30) Foreign Application Priority Data
Feb. 21, 2025 (KR) 10-2025-0023148

(51) Int. Cl. B01D 35/30; B01D 35/157; F25D 17/02

(52) U.S. Cl. CPC B01D 35/30; B01D 35/1573; F25D 17/02; B01D 2201/301; B01D 2201/4007; B01D 2201/4046; B01D 2201/4092

(57) ABSTRACT

Provided is a filter device for a refrigerator in which the filter device is installed in one side of the refrigerator and supplies purified water produced by filtering external raw water to an ice maker or a dispenser, and maintenance and replacement of the filter device is easily performed.

### CROSS-REFERENCE TO RELATED APPLICATION

This application claims priority to and the benefit of Korean Patent Application No. 10-2025-0023148, filed on 2025, 02, 21, the disclosure of which is incorporated herein by reference in its entirety.

### BACKGROUND

### Field

The present disclosure relates to a filter device for supplying raw water into a refrigerator, and more particularly, to a refrigerator including a filter device which is designed for easy maintenance and replacement.

### Description of Related Art

A refrigerator is a home appliance that supplies cold air generated using circulation of refrigerant to a storage compartment to store various types of storage objects in the storage compartment in a fresh state for a long time.

As illustrated in FIG. 1, the refrigerator may be manufactured by combining an outer casing 10 and an inner casing 20 with each other, and a plurality of storage compartments 30 may be formed therein.

In addition, a plurality of storage drawers 50 for storing stored goods therein may be formed inside the storage compartment 30.

As illustrated in FIGS. 2 and 3, the refrigerator may be provided with a first ice maker 81 for making ice and a dispenser 82 for filtering external raw water and supplying purified water to a user.

In addition, the refrigerator may individually include an ice maker for directly providing ice to the user and an ice maker for providing stored ice, as illustrated in FIGS. 4 and 5, according to the shape and purpose thereof.

In the refrigerator, a separate second ice maker 83 may be installed as shown in FIGS. 4 and 5.

In this case, the purified water purified by a filter device 60 may be supplied to the second ice maker 83 through an ice valve V3.

That is, as shown in FIGS. 2 to 5, in order to supply ice or purified water to the ice maker 81 and 83 or the dispenser 82, the filter device 60 for filtering external raw water to produce purified water is required.

In the conventional refrigerator, the filter device 60 is installed on top of a water tank 70 in a separate manner from the water tank in order to transfer the purified water produced to the water tank 70 without a separate power means.

In this regard, when the user manipulates a manipulation unit to transmit a signal for discharging the purified water or ice to the controller, the purified water stored in the water tank 70 is selectively supplied to the dispenser 81 or the ice maker 81 and 83 through a water discharge valve V2 or the ice valve V3.

However, in this case, the filter device 60 and the water tank 70 respectively occupy separate spaces in the refrigerator storage compartment 30, such that space utilization efficiency is reduced. When a failure occurs in the water purification system, the filter device 60 and the water tank 70 should be inspected, respectively.

Recently, in order to solve the above problem, as illustrated in FIG. 6, a scheme of accommodating a filter 600 and a water tank 700 together in a hexahedral filter casing 100 installed on one side of the storage drawer 50 and operating the filter 600 and the water tank 700 has been used.

This scheme has an advantage in that a space may be efficiently used. However, in order to replace the filter 600, an opening formed in a side surface of the filer casing facing the storage drawer is inevitably used. Thus, all of the plurality of storage drawers 50 disposed on the side surface of the filter casing 100 must be removed.

In addition, the filter 600 is detached in a lateral direction. Thus, in order to check whether the filter is mounted, the user should insert a head thereof into the refrigerator storage compartment 30 to check the filter or use a separate tool such as a reflector.

In addition, as illustrated in FIG. 7, a filter assembly may include the filter casing 100, the filter 600, the water tank 700, a filter bracket 200 connecting the filter and the water tank to each other, and a water valve 300 installed at one side of the filter bracket 200 to supply external raw water to the filter 600 and selectively supply purified water stored in the water tank 700 to an ice maker and a dispenser, wherein the filter, the water tank, the filter bracket, and the water valve are accommodated in the filter casing 100. However, in this case, there is a disadvantage in that the filter 600 is highly likely to be exposed to external contaminants whenever the side surface of the filter casing 100 is opened to replace the filter 600.

In addition, as illustrated in FIG. 8, a switch 500 acing as a means checking whether the filter 600 is mounted should be installed on a finishing cover 120 of the filter casing 100 in contact with the inner casing 20. Thus, an unnecessary space is required between the inner casing 20 and the filter casing 100, which leads to a decrease in space efficiency of the refrigerator.

### SUMMARY

A purpose of the present disclosure is to provide a system capable of facilitating replacement of a refrigerator filter.

In addition, a purpose of the present disclosure is to minimize contamination by preventing a filter assembly from being exposed to the outside even when the refrigerator filter is replaced.

In addition, a purpose of the present disclosure is to improve space efficiency by minimizing an space occupied by the filter assembly in the refrigerator.

A purpose of the present disclosure is to improve maintenance by allowing the filter assembly to be easily disassembled and assembled.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

A filter device of the present disclosure may be applied to a water purifier or a water purifier installed in a refrigerator.

A filter device of the present disclosure may occupy a minimized space in the refrigerator storage compartment to improve the space efficiency of the refrigerator.

In the filter device of the present disclosure, the user may replace the filter through an open side or front surface.

The filter is accommodated in the inner space of the filter casing coupled to the inner casing of the refrigerator.

A side or rear surface of the filter casing facing the refrigerator inner casing is open such that the inner space of the filter casing is defined by the inner casing.

The filter that needs to be periodically replaced is stored in a blocked manner from the remaining components in the filter casing by a partition wall.

The filter and the remaining components are connected to each other via a filter bracket passing through an opening formed in one side of the partition wall.

The filter is received in a separate receiving portion having open side and front surfaces for replacement of the filter.

The open side and front surfaces of the separate receiving portion may be covered by a cover.

A filter cap for holding one end of the filter is installed on an inner surface of the cover, so that the filter may be disassembled or assembled even in a state in which the cover is not detached from the filter casing.

Each of the remaining components such as the water tank, the water valve, and the filter bracket are fixedly installed on the filter casing and the inner casing.

A pipe for supplying external raw water to the filter and a pipe for supplying purified water which has been filtered to a dispenser or an ice maker are disposed in an area where the inner casing and the filter casing are in contact with each other to improve the space efficiency and aesthetics.

In order to achieve the above-described purpose, one aspect of the present disclosure provides a filter device for a refrigerator, wherein the refrigerator comprises an outer casing and an inner casing, wherein a storage compartment is formed in the inner casing, and at least one storage drawer is disposed in the storage compartment, wherein the filter device comprises: a filter casing installed between the storage drawer and the inner casing, wherein the filter casing is composed of: a first receiving portion having one open side surface and an open front surface, wherein a filter for filtering external raw water is received in an inner space of the first receiving portion; a second receiving portion separate from the first receiving portion, wherein a water tank is received in an inner space of the second receiving portion; and a partition wall disposed between the first and second receiving portions so as to divide the filter casing into the first and second receiving portions, wherein an opening is formed in one side of the partition wall; and a filter bracket having one end passing through the opening and detachably connected to the filter, and the other end detachably connected to the water tank.

In one embodiment of the filter device, the filter bracket includes: a head cover passing through the opening and protruding into the first receiving portion so as to be coupled to the filter; a water tank cover coupled to the water tank; a supply flow path for transferring raw water supplied from an external source to the filter; and a water discharge flow path for transferring purified water produced by filtering the raw water using the filter to the water tank.

In one embodiment of the filter device, one side of the supply flow path is connected to a water inlet pipe and the other side thereof is connected to a water inlet of the filter, wherein one side of the water discharge flow path is connected to a water outlet of the filter and the other side thereof is connected to a water inlet of the water tank.

In one embodiment of the filter device, a water valve is connected to the filter bracket and selectively supplies the purified water stored in the water tank to at least one of a first ice maker, a second ice maker, or a dispenser installed at each side of the refrigerator.

In one embodiment of the filter device, a cover is detachably coupled to the filter casing so as to cover the open side and front surfaces of the first receiving portion such that the inner space of the first receiving portion is closed.

In one embodiment of the filter device, a coupling protrusion formed at one side of the cover is coupled to a coupling groove formed at one side of the filter casing such that the cover is fixed to the filter casing.

In one embodiment of the filter device, a filter support portion protruding from one side of the partition wall facing the first receiving portion supports one end of the filter thereon.

In one embodiment of the filter device, the first receiving portion is disposed on top of the second receiving portion.

In one embodiment of the filter device, one side surface and a rear surface of the filter casing facing the inner casing are open such that an inner space of the inner casing is defined by the inner casing.

In one embodiment of the filter device, a first guide rail structure configured to guide the storage drawer to be slidably movable in a frontward direction of the refrigerator is formed on one side surface of the filter casing facing the storage drawer, .

In one embodiment of the filter device, the first guide rail structure includes: a first rail configured to support one side end of the storage drawer; and a bottom fixing portion configured to fix a lower end of the filter casing to the inner casing, wherein a guide roller is formed on the first guide rail structure and is positioned in front of the first rail.

In one embodiment of the filter device, a filter cap configured to hold one end of the filter is disposed on an inner surface of a front portion of the cover, wherein a handle connected to the filter cap and configured to rotate the filter held by the filter cap is disposed on an outer surface of the front portion the cover.

In one embodiment of the filter device, a filter bracket support portion extends from one side surface of a portion of the filter bracket accommodated in the second receiving portion, wherein each fastening hole is formed in each of the filter bracket support portion and the one side surface of the portion of the filter bracket, wherein each screw passes through each fastening hole to fasten each of the filter bracket support portion and the filter bracket to the filter casing.

In one embodiment of the filter device, a bottom fastening hole is formed in the bottom fixing portion, wherein a screw passes through the bottom fastening hole to fasten the first guide rail structure to the inner casing.

In one embodiment of the filter device, a water outlet of the water tank is connected to a water outlet pipe in fluid communication with at least one of the first ice maker, the second ice maker, or the dispenser, wherein the water outlet pipe is disposed in and extends along a space between the inner casing and the outer casing.

In one embodiment of the filter device, the water valve is connected to a controller via a connector and is controlled by the controller or receives external power via the connector.

In one embodiment of the filter device, the connector is connected to the controller or an external power source via an openable or closable portion formed in one side surface of the inner casing.

In order to achieve the above-described purpose, another aspect of the present disclosure provides a filter assembly comprising: a filter casing disposed in a storage compartment defined by an inner casing of a refrigerator, wherein the filter casing contacts the inner casing, wherein the filter casing includes: a first receiving portion having one open side surface and an open front surface, wherein a filter for filtering external raw water is received in an inner space of the first receiving portion; a second receiving portion separate from the first receiving portion, wherein a water tank is received in an inner space of the second receiving portion; and a partition wall disposed between the first and second receiving portions so as to divide the filter casing into the first and second receiving portions; a cover detachably coupled to the filter casing so as to cover the one open side surface and the open front surface of the first receiving portion; and a filter bracket coupled to one end of the filter and one end of the water tank, wherein the filter bracket is configured to supply the external raw water to the filter, and to transfer purified water produced by filtering the raw water using the filter to the water tank.

In one embodiment of the filter assembly, the one end of the filter is rotatably coupled to a head cover of the filter bracket, wherein an opening is formed in one side of the

partition wall, wherein the head cover is inserted through opening so as to protrude into the first receiving portion and so as to seal the opening.

In one embodiment of the filter assembly, one side surface and a rear surface of the filter casing facing the inner casing are open such that an inner space of the inner casing is defined by the inner casing.

In one embodiment of the filter assembly, a water valve is connected to the filter bracket and selectively supplies the purified water stored in the water tank to at least one of a first ice maker, a second ice maker, or a dispenser installed at each side of the refrigerator.

In one embodiment of the filter assembly, the purified water stored in the water tank is supplied via a water outlet pipe in fluid communication with at least one of the first ice maker, the second ice maker, or the dispenser, wherein the water outlet pipe passes through a portion of the inner casing in contact with the filter casing and is disposed in and extends along a space between the inner casing and an outer casing of the refrigerator.

In one embodiment of the filter assembly, the water valve is connected to a controller via a connector and is controlled by the controller or receives external power via the connector, wherein the connector is connected to the controller or an external power source via an openable or closable portion formed in one side surface of the inner casing.

Specific matters of other embodiments are included in specific contents and drawings for carrying out the present disclosure.

According to the present disclosure, the filter, the water tank, the filter bracket, the water valve constituting the filter assembly are gathered and installed in one side of the refrigerator storage compartment, thereby increasing space efficiency of the refrigerator compared to a case in which the components are separately installed in a non-gathered manner.

In addition, the filter to be frequently replaced and the remaining components are accommodated in the filter casing, and the filter and the remaining components may be separately received in the separate receiving spaces to protect the filter from external pollutants.

In the conventional manner, the filter is removed in the lateral direction. However, according to the present disclosure, the filter is replaced through the open side and front surfaces, thereby removing the use of the separate tool to check whether the filter is mounted or removing the inconvenience of placing a separate checking means.

According to the present disclosure, the filter is separately mounted in the filter receiving portion having the side surface and the front surface are open, and the open side and front surfaces are covered with the cover to protect the filter from external pollutants.

According to the present disclosure, the filter cap for holding one end of the filter is provided on the inner surface of the cover. The handle connected to the filter cap to rotate the filter cap is disposed on the outer surface of the cover. Thus, the filter can be easily detached using the filter cap and the handle.

According to the present disclosure, the filter may be replaced through the open front surface, thereby removing the inconvenience of having to remove the plurality of storage drawers disposed on the side surface of the filter assembly for filter replacement in the conventional manner.

According to the present disclosure, the pipe for supplying external raw water to the filter or supplying the purified water filtered by the filter to the ice maker or the dispenser passes through the inner casing in an area in contact with the filter casing, thereby improving the space efficiency and aesthetic effects.

In addition to the above-described effects, specific effects of the present disclosure will be described together while describing specific matters for implementing the present disclosure.

### BRIEF DESCRIPTION OF DRAWINGS

FIG. 1 is a front perspective view of a refrigerator in which a filter device is installed.

FIG. 2 and FIG. 3 are operation diagrams illustrating a supply sequence of purified water in a refrigerator in which a filter device and a water tank are separately installed and a single dispenser and a single ice maker are installed.

FIGS. 4 and 5 are operation diagrams illustrating a supply sequence of purified water in a refrigerator in which a filter device and a water tank are separately installed and one dispenser and two ice makers are installed.

FIG. 6 is a front perspective view illustrating that a filter is accommodated in a filter casing installed in one side of a refrigerator according to the related art.

FIG. 7 is a perspective view of a filter assembly accommodated in a filter casing installed in one side of a refrigerator according to the related art.

FIG. 8 is a side perspective view of a conventional refrigerator in which a filter casing has a finishing casing installed on a surface thereof facing an inner casing, and a switch for checking whether a filter is mounted in the filter casing is installed on the finishing casing.

FIG. 9 is a perspective view illustrating an embodiment in which a filter casing of the present disclosure is installed in one side of a refrigerator storage compartment.

FIG. 10 is a side perspective view simultaneously showing a filter and a filter casing accommodating the same therein according to the present disclosure.

FIG. 11 is a side perspective view showing the inside of the filter casing of the present disclosure.

FIG. 12 is a side perspective view showing that the filter is installed in the first receiving portion having an open surface according to the present disclosure.

FIG. 13 is a side perspective view showing that the open surface of the first receiving portion is covered and sealed with a cover according to the present disclosure.

FIG. 14 is a side view showing an embodiment of the inside of the filter casing of the present disclosure.

FIG. 15 is a side view showing another embodiment of the inside of the filter casing of the present disclosure.

FIG. 16 is a side perspective view showing that a handle for detaching a filter is installed on the cover according to the present disclosure.

FIG. 17 is a side perspective view showing that an accommodation space if the filter casing in contact with the inner casing is defined by the inner casing according to the present disclosure.

FIG. 18 is a side perspective view illustrating that a connector and a pipe for supplying purified water passes through the inner casing in an area in contact with the filter casing according to the present disclosure.

### DETAILED DESCRIPTIONS

The above-mentioned purposes, features, and advantages will be described in detail later with reference to the attached drawings, so that those skilled in the art in the technical field to which the present disclosure belongs may easily implement the technical ideas of the present disclosure. In describing the present disclosure, upon determination that a detailed description of the publicly known technology related to the present disclosure may unnecessarily obscure the gist of the present disclosure, the detailed description will be omitted. Hereinafter, a preferred embodiment according to the present disclosure will be described in detail with reference to the attached drawings. In the drawings, identical reference numerals are used to indicate identical or similar components.

Although first, second, and the like are used to describe various components, these components are not limited by such terms. Such terms are only used to distinguish one component from another component, and unless specifically stated to the contrary, a first component may also be a second component. Furthermore, when a first component is described as being “connected” or “coupled” to a second component, the components may be directly connected or coupled to each other, but a third component may be “interposed” between the components or the components may be “connected” or “coupled” to each other via the third components.

As used herein, the singular constitutes "a" and "an" are intended to include the plural constitutes as well, unless the context clearly indicates otherwise. In this application, terms such as "composed of" or "include" should not be construed as necessarily including all of various components or operations described herein, but should be construed that some components or operations among those may not be included or additional components or operations may be further included.

Hereinafter, a filter device and a refrigerator according to some embodiments of the present disclosure will be described.

### First Embodiment

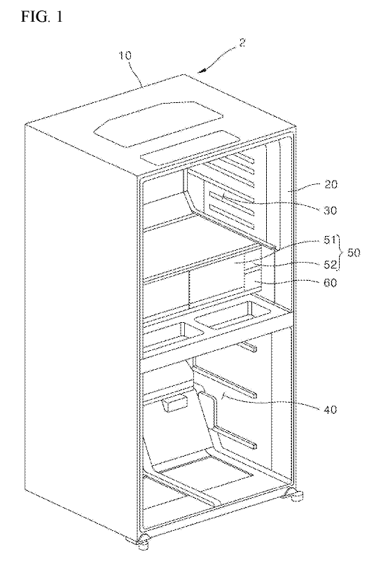

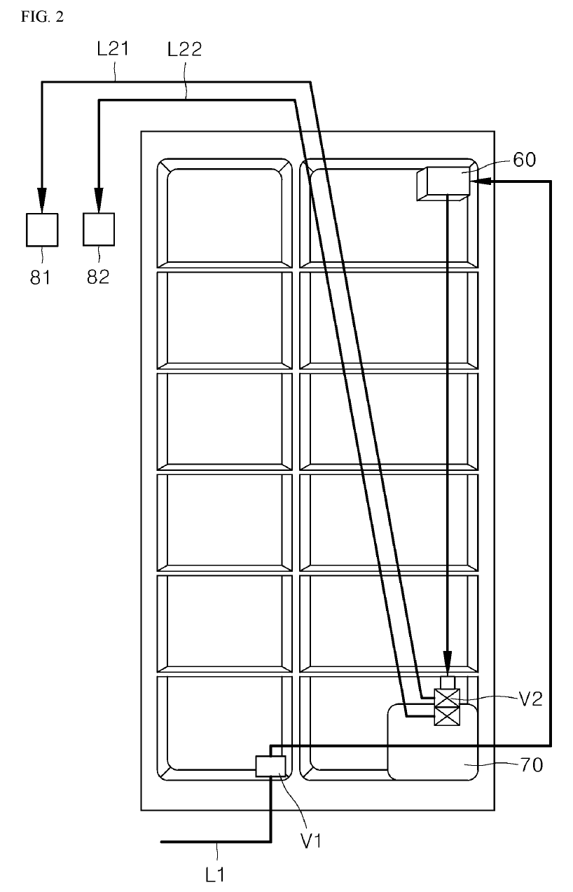

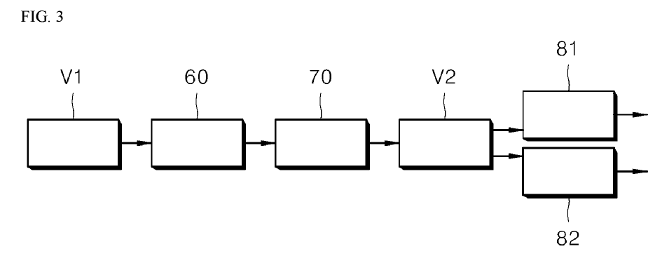

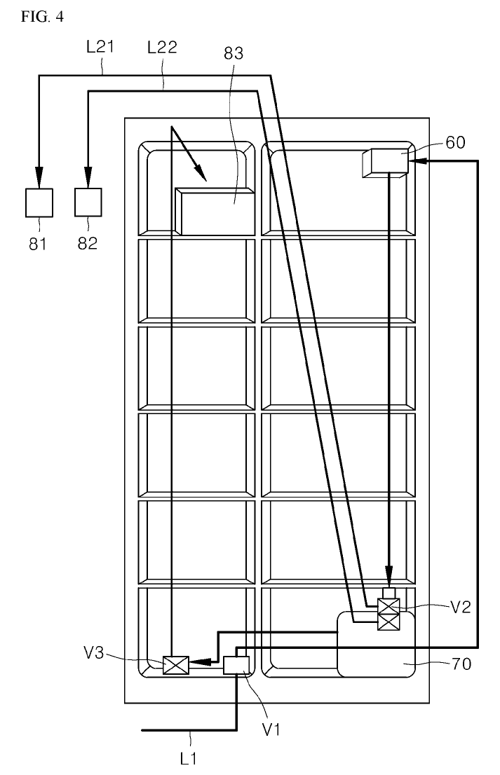

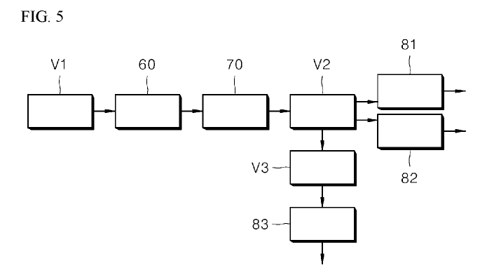

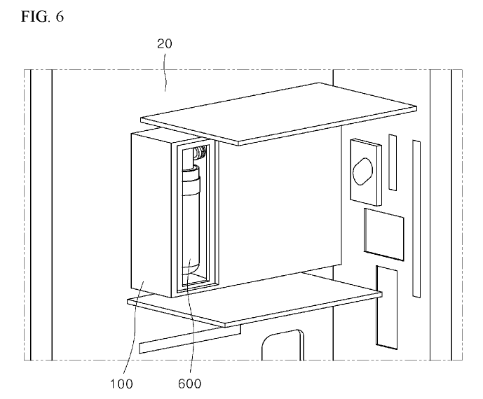

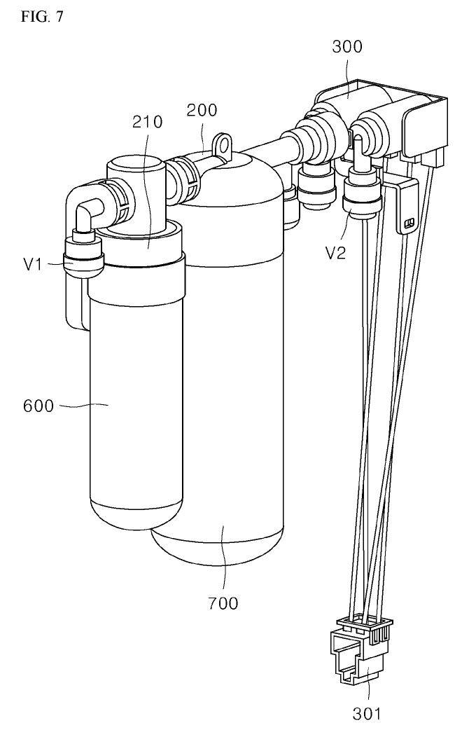

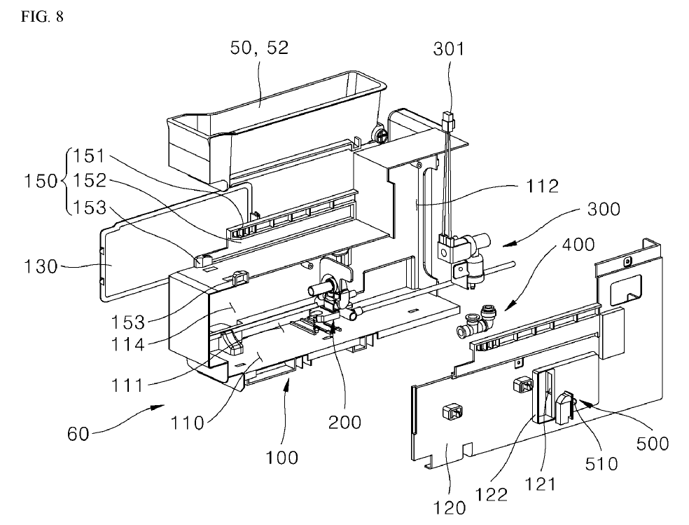

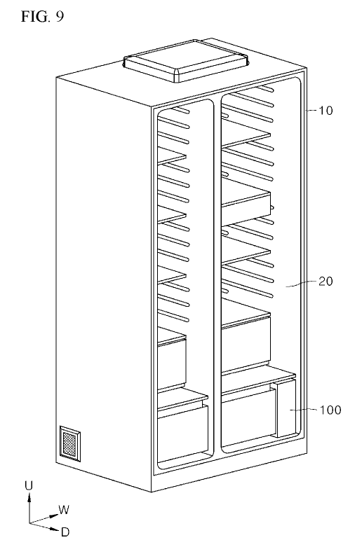

First, the filter device according to an embodiment of the present disclosure and a connection relationship between main components constituting the filter device will be described with reference to FIGS. 1 and 9.

A refrigerator 1 may have an outer appearance defined by a cabinet 2 including one or more storage compartments and a plurality of doors 3 and 4 capable of opening and closing an opened front surface of the cabinet 2.

The cabinet 2 may include an outer casing 10 defining an outer surface of the refrigerator 1 and an inner casing 20 defining an inner surface thereof.

The outer casing 10 and the inner casing 20 are spaced apart from each other so as to define a space therebetween. The space may be filled with a thermal insulating material including a foam.

An inner space of the inner casing 20 may be divided into one or more storage spaces.

The inner casing 20 may have one or more storage compartments defined therein, which may include, for example, a first storage compartment 30 and a second storage compartment 40.

For example, the first storage compartment 30 may be a refrigerating compartment, and the second storage compartment 40 may be a freezing compartment. However, embodiments of the present disclosure are not limited thereto.

The first storage compartment 30 and the second storage compartment 40 may be vertically arranged. However, embodiments of the present disclosure are not limited thereto, and the first storage compartment 30 and the second storage compartment 40 may be arranged side by side and in a horizonal direction.

A filter casing 100 in which the filter of the filter device is accommodated may be disposed in one side of the first storage compartment 30 or the second storage compartment 40.

The filter casing 100 may be disposed adjacent to one or more storage drawers 50.

For example, the filter casing 100 and the one or more storage drawers 50 may be arranged side by side.

The storage drawer 50 adjacent to the filter casing 50 in the left-right direction is configured to extend from or retract into the first storage compartment 30 or the second storage compartment 40 in a sliding manner and in the front-rear direction, thereby increasing space utilization in a narrow space.

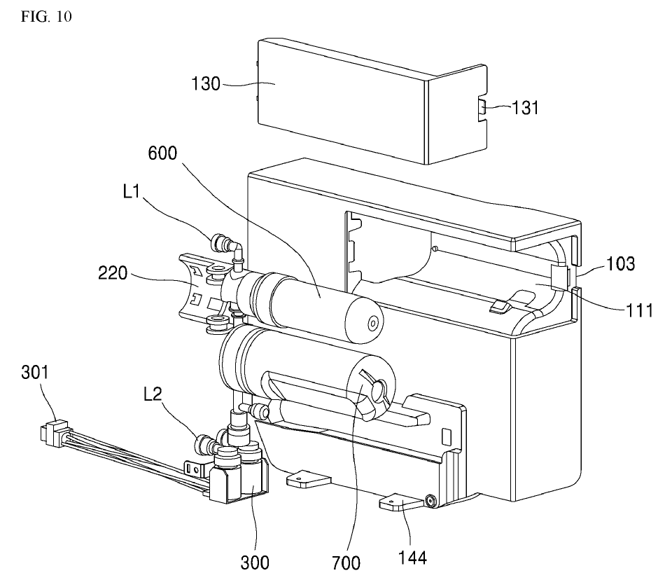

FIG. 10 illustrates the filter casing 100 and a filter assembly accommodated in the filter casing 100.

A first guide rail structure 140 for guiding the movement of the storage drawer 50 may be formed on an outer side surface of the filter casing 100 facing the storage drawer 50.

The first guide rail structure 140 may include a first rail 141 supporting one side end of the first storage drawer 51, and the first rail 141 may extend in an elongated manner in the front-rear direction to allow the first storage drawer 51 to slide thereon in the front-rear direction.

The first guide rail structure 140 may include a pair of bottom fixing portions 144 respectively extending outwardly from a front end and a rear end of a lower end of the filter casing 100 and along a bottom surface of the first storage compartment 30 to fix the filter casing 100 to the inner casing 20.

In addition, a bottom fastening hole 1441 for fixing the filter casing 100 to the inner casing 20 with a screw may pass through the bottom fixing portion.

A roller 143 may be disposed in front of the first rail 141 so that one end of the storage drawer 50 may easily slide along and on the roller in the front-rear direction.

A first guide groove 142 recessed inwardly may be formed under the first rail 141 to provide a passage in which a wheel for guiding the movement of the storage drawer 50 is received. The wheel moves along the first guide groove 142.

The filter casing 100 may be divided into a first receiving portion 111 and a second receiving portion 112.

A partition wall 101 may be disposed between the first receiving portion 111 and the second receiving portion 112 and may divide the filter casing 100 into the first receiving portion 111 and the second receiving portion 112.

The first receiving portion 111 may have an inner space defined therein and may have an open side surface facing the storage drawer 50 and an open front surface facing the door.

The open side and front surfaces of the first receiving portion 111 may be covered with a cover 130 formed in a shape corresponding to a shape of a combination of the open surfaces. The cover may be detachably coupled to the first receiving portion 111.

A coupling protrusion 131 is installed at one side of the cover 130 so as to be coupled to a coupling groove 103 formed at one side of the filter casing 100, so that the cover 130 may be fixed to the casing 100.

A filter 600 for producing purified water by filtering external raw water may be received in the first receiving portion 111.

Accordingly, the filter 600 may be inserted into or removed from the first receiving portion 111 through the open side surface or the open front surface of the first receiving portion 111 in a state in which the cover 130 has been removed from the first receiving portion 111.

In addition, a water tank 700 for storing therein the purified water produced by the filter 600 may be received in the second receiving portion 112.

In addition, a water valve 300 for selectively supplying the purified water stored in the water tank 700 to a first ice maker 81, a second ice maker 83, or a dispenser 82 according to a command of a user or under control of a controller may be received in the second receiving portion 112.

In addition, a main body of a filter bracket 200 connecting the filter 600, the water tank 700, and the water valve 300 to each other may be accommodated in the second receiving portion 112.

The filter bracket 200 may include a head cover 210 protruding toward the first receiving portion 111 through an opening 115 so as to be coupled to the filter 600, a water tank cover coupled to the water tank 700, a supply flow path for transferring raw water supplied from the outside to the filter 600, and a water discharge flow path for transferring the purified water produced by filtering the raw water using the filter 600 to the water tank 700.

One side of the supply flow path may be connected to a water inlet pipe L1, the other side thereof may be connected to an inlet of the filter 600, and one side of the water discharge flow path may be connected to an outlet of the filter 600 and the other side thereof may be connected to an inlet of the water tank 700.

A water outlet of the water tank 700 may be connected to a water outlet pipe L2 that is in fluid communication with the first ice maker 81, the second ice maker 83, or the dispenser 82.

For example, the water outlet pipe L2 may be connected to a branch pipe 400 from which a first water outlet pipe L21, a second water outlet pipe L22, or a third water outlet pipe (not shown) is branched to supply the purified water individually to the components.

The water valve 300 may receive a command or power from the refrigerator controller via a connector 301 connected thereto via a wire.

The water inlet pipe L1 and the connector 301 may be connected to the filter assembly through a surface of the inner casing 20 in contact with the filter casing 100.

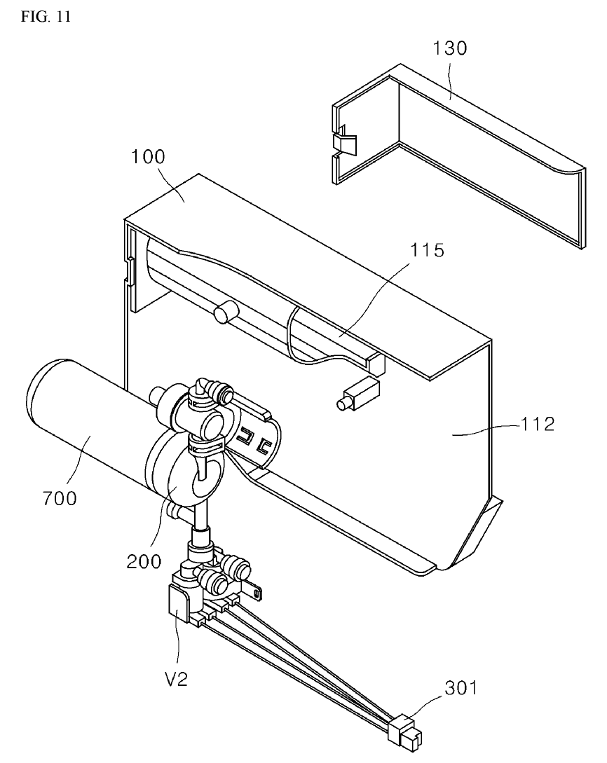

FIG. 11 illustrates a filter assembly disposed inside the filter casing 100 formed in contact with the inner casing 20.

The filter bracket 200 may be screw-coupled to the filter casing 100 using a screw passing through a fastening through 2201 formed in a filter bracket support 220 extending to one side.

In addition, a plurality of fastening holes 2001 may be formed in one side of the filter bracket 200 and be screw-coupled to and fixed to the filter casing 100 or the inner casing 20 using screws.

The opening 115 may be formed in one side of the partition wall 101 that distinguishes the first receiving portion 111 from the second receiving portion 112.

The head cover 210 extending from the body of the filter bracket 200 protrudes through the opening 115 into the first receiving portion 111.

In this case, the head cover 210 may seal the opening 115 so that external foreign substances are not introduced into the second receiving portion 112.

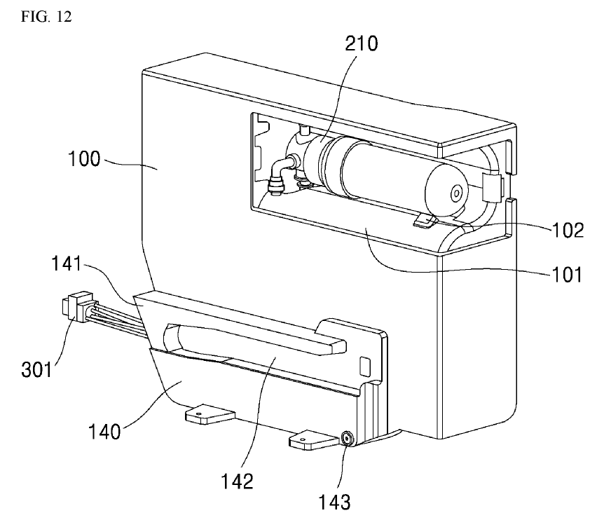

FIG. 12 illustrates that the filter 600 received in the first receiving portion 111is mounted on the head cover 210.

When the service life of the filter 600 has expired, the user may first remove the cover 130 from the filter casing and then remove the filter 600 from the filter casing thorough the open side or front surface of the filter casing 100.

The head cover 210 may be rotatably coupled to one end of the filter 600 in which the water inlet and the water outlet are formed.

As described above, the filter 600 may be inserted into or removed from the first receiving portion 111 through the open side surface and the open front surface of the first receiving portion 111 and be attached to and detached from the head cover 210.

Therefore, unlike the conventional filter device, the user may visually check whether the filter 600 is mounted onto the head cover 210 without a separate tool or device.

A filter support portion 102 configured to allow the filter 600 to be stably fixedly seated may protrude from one side of the partition wall 101 facing the first receiving portion 111.

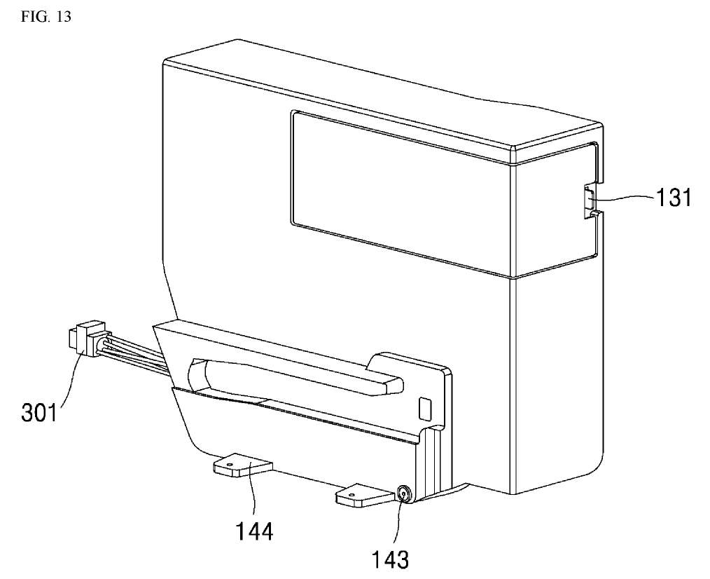

FIG. 13 illustrates that the first receiving portion 111 is sealed with the cover 130.

The cover 130 serves to protect the first receiving portion 111 from various kinds of stored objects in the storage compartment 30 or contaminants generated in the process of loading and unloading the stored objects into and from the storage compartment 30.

A button pressing type coupling protrusion 131 is formed on one side of the cover 130 to improve the ease of the cover 130 of attachment to and detachment from the filter casing 100.

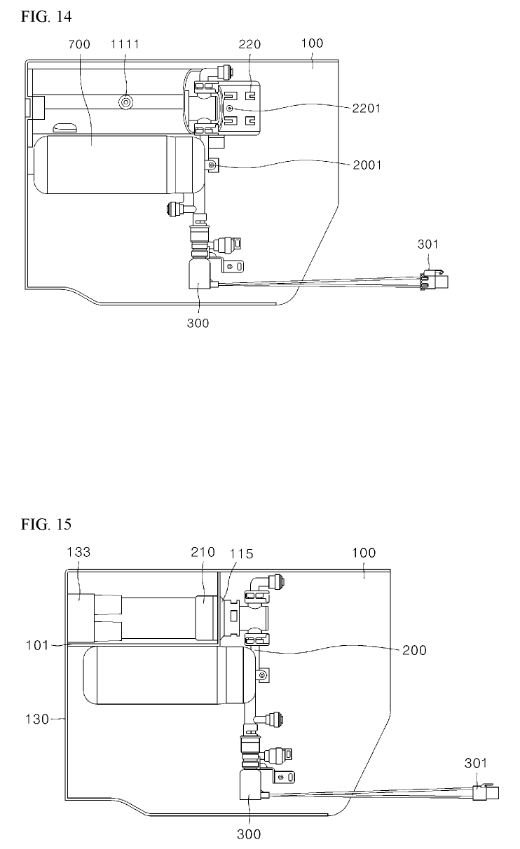

FIG. 14 is a perspective view of the inside of the filter casing 100 in a direction facing toward the inner casing 20.

The partition wall 101 may separate the first receiving portion 111 and the second receiving portion 112 from each other. A fastening hole 1111 may be formed in one side surface of the filter casing 100 facing the inner casing 20. A screw may pass through the fastening hole 1111 such that the filter casing 100 is coupled to the inner casing 20.

It is obvious that the fastening hole 1111 formed in the first receiving portion 111 may be coupled to a coupling means other than a screw. The above-described fastening hole formed in each of the filter bracket support portion 220 and the filter bracket 200 may be coupled to a coupling means other than a screw.

### Second Embodiment

In the first embodiment, after the user has removed the cover 130 from the filler casing, the filter 600 is detached from the first receiving portion 111 through the open side surface or the open front surface exposed to the outside.

However, this scheme has a disadvantage in that the user has to directly grip the filter 600, and when the filter 600 is contaminated due to a failure or damage, it is difficult for the user to maintain a grip force while gripping the filter.

In addition, the contamination of the filter assembly including the filter 600 may occur at the moment when the cover 130 is removed from the first receiving portion 111 and the filter 600 is removed from the head cover 210.

Therefore, it is important that the first receiving portion 111 is blocked from the outside even at the moment when the filter 600 is removed from the head cover 210.

FIG. 15 is a perspective view illustrating the inside of the filter casing 100 in a direction facing toward the inner casing 20 in the present embodiment.

A filter cap 133 for holding an opposite end to one end of the filter 600 coupled to the head cover 210 is formed on an inner side surface of the cover 130.

A plurality of sleeves are formed on an end of the filter cap 133 and are arranged along a circumference of the end of the filter cap 133.

The sleeves may be installed to be spaced apart from each other by a predetermined distance so that not only the filter 600 may be easily held by the filter cap 133 and but also a structure having a diameter slightly different from a diameter of the filter 600 may be held by the filter cap 133.

In addition, a contact protrusion (not shown) may be formed on a contact surface between the sleeve and the filter 600 to improve the holding force of the filter 600.

The filter cap 133 may be rotatably installed on the cover 130.

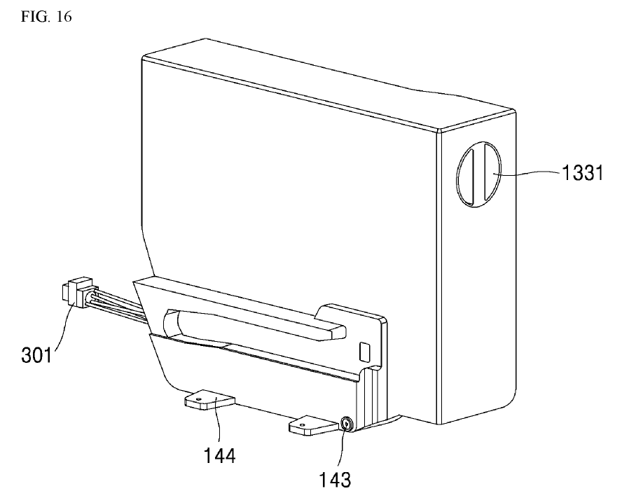

As shown in FIG. 16, a handle 1331 connected to the filter cap 133 may be disposed on an outer surface of the cover 130.

When the user rotates the handle 1331, the filter 600 having the other end heled by the filter cap 133 may also rotate in the same direction as the rotation direction of the handle.

That is, when the user wants to replace the filter 600 after the service life of the filter has expired, the user may rotate the handle 1331 in a state in which the cover 130 is coupled to the filter casing 100, the filter 600 may also be rotated and removed from the head cover 210.

In this case, the filter 600 has been removed from the head cover, and moves toward a position of the handle 1331. To this end, a spare space for allowing the movement of the filter may be defined in the sleeve or the filter cap 133.

When the filter 600 is disassembled from the filter casing, the user may remove the cover 130 by applying a pressure to the coupling protrusion 131.

In addition, after a new filter 600 is fitted into the filter cap 133, the coupling protrusion of the cover 130 is again fastened to the coupling groove 103 to seal the inner space of the first receiving portion 111. Then, the handle 1331 is rotated in the opposite direction to the direction in which the handle is rotated such that the filter 600 is disassembled from the filter casing. Thus, the filter 600 may be coupled to the head cover 210.

For example, a rotation direction and a rotation degree of the handle 1311 for disassembling or coupling the filter 600 from and to the filter casing under the rotation of the handle 1311 may be indicated using as at least one of printing, intaglio, or embossing on the handle 1311 of the cover 130.

The user recognizes the rotation direction and the rotation amount for disassembling or coupling the filter 600 from or to the filter casing with reference to the indication and rotates the handle 1311 according to the recognized rotation direction and rotation amount, thereby minimizing the exposure of the filter 600 and the head cover 210 coupled to the filter 600 to the outside.

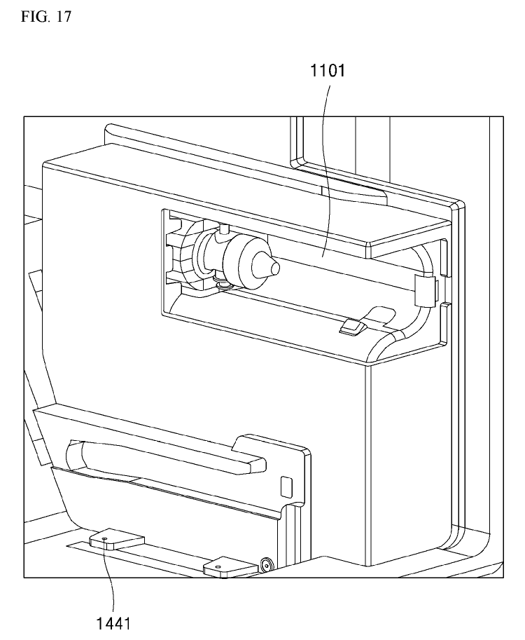

FIG. 17 illustrates another technical feature of the present disclosure.

A side surface of the filter casing 100 facing the inner casing 20 is open such that an accommodation space of the filter casing is defined by the inner casing without a separate side wall of the filter casing.

In order to more closely couple the filter casing 100 and the inner casing 20 to each other, a coupling edge corresponding to a contact area of thereof with the filter casing 100 may be formed on the inner side surface of the inner casing 20.

The coupling edge may act as a reference point when the filter casing 100 is disassembled from the inner casing and then re-coupled thereto, and may prevent an unnecessary gap from occurring, thereby serving as a primary blocking line for completely protecting the purified water or the raw water of the second receiving portion 112 or the first receiving portion 111 from external contaminants.

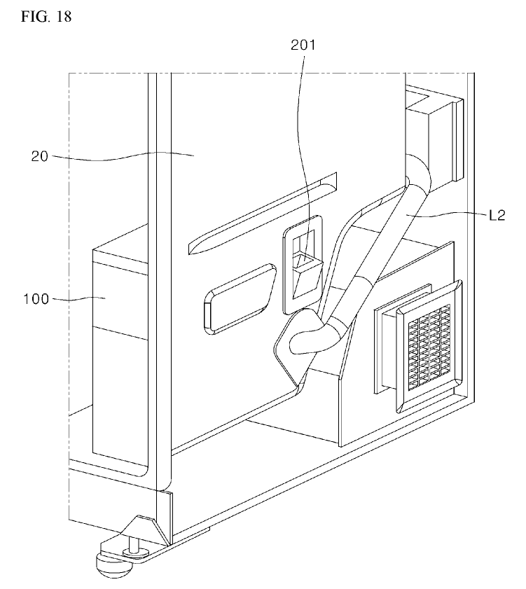

FIG. 18 illustrates that the water outlet pipe L2 through which the purified water filtered by the filter 600 is discharged and a wire for supplying a control command from the controller and power to the connector 301 are disposed on a contact surface where the filter casing 100 and the inner casing 20 are in contact with each other and pass through the inner casing 20.

Both an inlet of the water outlet pipe L2 and an openable or closable portion 201 through which the wire passes through the inner casing 20 may be configured such that the storage compartment 30 is prevented from being exposed to the user, thereby enhancing an aesthetic effect and be configured to prevent the occurrence of an additional unnecessary space.

In some cases, the water outlet pipe L2 may be connected to the branch pipe as described above which may selectively supply the purified water filtered by the filter 600 to the first ice maker 81, the second ice maker 83, or the dispenser 82.

The features of the filter device installed in the refrigerator of the present disclosure are summarized as follows.

In the conventional filter device installed in the refrigerator, as described above, the filter 60 and the water tank 70 are separately installed, thereby reducing space efficiency.

In order to overcome this shortcoming, recently, a scheme of accommodating the filter 600 and the water tank 700 in one filter casing 100 has been used. However, in this scheme, the filter 600 may be inserted into the casing and withdrawn therefrom only through the side surface of the filter casing 100, so that the user may have to remove all of the storage drawers 50 disposed on the side surface of the filter casing to replace the filter 600.

In addition, when the filter 600 is replaced, the components other than the filter 600, that is, the water tank 700, the filter bracket 200, or the water valve 300, is exposed to the outside and thus is vulnerable to external contamination.

In addition, in the filter assembly of the related art, in order to check whether the filter 600 is accurately mounted onto the head cover 210, the user should insert the head into the storage compartment or use a tool such as a reflector. This is inconvenient.

For example, in order to reduce such inconvenience, a separate finishing cover 120 is installed on a surface of the filter casing 100 in contact with the inner casing 20, and the switch 500 is installed on the finishing cover 120 to check whether the filter 600 is mounted.

However, in this case, the filter casing 100 and the inner casing 20 are spaced from each other by a predetermined distance, thereby deteriorating the space efficiency of the entire storage compartment 30.

In the present disclosure, the filter 600 is selectively detached from the filter casing through the open side surface or the open front surface of the first receiving portion 111. Thus, the user may visually check whether the filter is mounted on the head cover 210, and thus the switch 500 is not required and thus there is no need for the separate finishing cover 120.

Accordingly, there is an advantage that unnecessary waste of the refrigerator storage compartment 30 does not occur, and a larger amount of storage materials may be loaded into the storage compartment.

Above all, the filter 600 which need to be frequently replaced is disposed in the first receiving space, while the water tank 700 and the water valve 300 that do not need to be regularly replaced are disposed in the second receiving portion 112 which is not opened or closed by the cover 130 detachably coupled thereto, thereby always maintaining the water tank 700 and the water valve 300 in a clean state.

In addition, as described above in another embodiment, the filter cap 133 configured to hold one end of the filter 600 is formed on the inner surface of the cover 130 detachably coupled to the filter casing 100 of the present disclosure. The handle 1331 connected to the filter cap 133 and rotatable is disposed on the outer surface of the cover 130. Thus, the filter 600 may be detached from the casing by the user rotating the handle while the filter is not exposed to the outside.

Although the embodiments of the present disclosure have been described in more detail with reference to the accompanying drawings, the present disclosure is not necessarily limited to these embodiments, and may be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects. In addition, even though an effect of a configuration of the present disclosure is not explicitly described in describing the embodiment of the present disclosure above, it is obvious that the predictable effect from the configuration should be recognized.

What is claimed is:

1. A filter device for a refrigerator, wherein the refrigerator comprises an outer casing and an inner casing, wherein a storage compartment is formed in the inner casing, and at least one storage drawer is disposed in the storage compartment, wherein the filter device comprises:
a filter casing installed between the storage drawer and the inner casing, wherein the filter casing is composed of:
a first receiving portion having one open side surface and an open front surface, wherein a filter for filtering external raw water is received in an inner space of the first receiving portion;
a second receiving portion separate from the first receiving portion, wherein a water tank is received in an inner space of the second receiving portion; and
a partition wall disposed between the first and second receiving portions so as to divide the filter casing into the first and second receiving portions, wherein an opening is formed in one side of the partition wall; and
a filter bracket having one end passing through the opening and detachably connected to the filter, and the other end detachably connected to the water tank.

2. The filter device of claim 1, wherein the filter bracket includes:
a head cover passing through the opening and protruding into the first receiving portion so as to be coupled to the filter;
a water tank cover coupled to the water tank;
a supply flow path for transferring raw water supplied from an external source to the filter; and
a water discharge flow path for transferring purified water produced by filtering the raw water using the filter to the water tank.

3. The filter device of claim 2, wherein one side of the supply flow path is connected to a water inlet pipe and the other side thereof is connected to a water inlet of the filter,
wherein one side of the water discharge flow path is connected to a water outlet of the filter and the other side thereof is connected to a water inlet of the water tank.

4. The filter device of claim 3, wherein a water valve is connected to the filter bracket and selectively supplies the purified water stored in the water tank to at least one of a first ice maker, a second ice maker, or a dispenser installed at each side of the refrigerator.

5. The filter device of claim 1, wherein a cover is detachably coupled to the filter casing so as to cover the open side and front surfaces of the first receiving portion such that the inner space of the first receiving portion is closed.

6. The filter device of claim 5, wherein a coupling protrusion formed at one side of the cover is coupled to a coupling groove formed at one side of the filter casing such that the cover is fixed to the filter casing.

7. The filter device of claim 5, wherein a filter support portion protruding from one side of the partition wall facing the first receiving portion supports one end of the filter thereon.

8. The filter device of claim 1, wherein the first receiving portion is disposed on top of the second receiving portion.

9. The filter device of claim 1, wherein one side surface and a rear surface of the filter casing facing the inner casing are open such that an inner space of the inner casing is defined by the inner casing.

10. The filter device of claim 9, wherein a first guide rail structure configured to guide the storage drawer to be slidably movable in a frontward direction of the refrigerator is formed on one side surface of the filter casing facing the storage drawer,
wherein the first guide rail structure includes:
a first rail configured to support one side end of the storage drawer;
a bottom fixing portion configured to fix a lower end of the filter casing to the inner casing, and
a guide roller formed on the first guide rail structure and positioned in front of the first rail,
wherein a bottom fastening hole is formed in the bottom fixing portion, and screw passes through the bottom fastening hole to fasten the first guide rail structure to the inner casing.

11. The filter device of claim 5, wherein a filter cap configured to hold one end of the filter is disposed on an inner surface of a front portion of the cover,
wherein a handle connected to the filter cap and configured to rotate the filter held by the filter cap is disposed on an outer surface of the front portion the cover.

12. The filter device of claim 1, wherein a filter bracket support portion extends from one side surface of a portion of the filter bracket accommodated in the second receiving portion,
wherein each fastening hole is formed in each of the filter bracket support portion and the one side surface of the portion of the filter bracket,
wherein each screw passes through each fastening hole to fasten each of the filter bracket support portion and the filter bracket to the filter casing.

13. The filter device of claim 4, wherein a water outlet of the water tank is connected to a water outlet pipe in fluid communication with at least one of the first ice maker, the second ice maker, or the dispenser,
wherein the water outlet pipe is disposed in and extends along a space between the inner casing and the outer casing.

14. The filter device of claim 4, wherein the water valve is connected to a controller via a connector and is controlled by the controller or receives external power via the connector.

15. The filter device of claim 14, wherein the connector is connected to the controller or an external power source via an openable or closable portion formed in one side surface of the inner casing.

16. A filter assembly comprising:
a filter casing disposed in a storage compartment defined by an inner casing of a refrigerator, wherein the filter casing contacts the inner casing, wherein the filter casing includes:
a first receiving portion having one open side surface and an open front surface, wherein a filter for filtering external raw water is received in an inner space of the first receiving portion;
a second receiving portion separate from the first receiving portion, wherein a water tank is received in an inner space of the second receiving portion; and
a partition wall disposed between the first and second receiving portions so as to divide the filter casing into the first and second receiving portions;
a cover detachably coupled to the filter casing so as to cover the one open side surface and the open front surface of the first receiving portion; and
a filter bracket coupled to one end of the filter and one end of the water tank, wherein the filter bracket is configured to supply the external raw water to the filter, and to transfer purified water produced by filtering the raw water using the filter to the water tank.

17. The filter assembly of claim 16, wherein the one end of the filter is rotatably coupled to a head cover of the filter bracket,
wherein an opening is formed in one side of the partition wall,
wherein the head cover is inserted through opening so as to protrude into the first receiving portion and so as to seal the opening.

18. The filter assembly of claim 16, wherein one side surface and a rear surface of the filter casing facing the inner casing are open such that an inner space of the inner casing is defined by the inner casing.

19. The filter assembly of claim 18, wherein a water valve is connected to the filter bracket and selectively supplies the purified water stored in the water tank to at least one of a first ice maker, a second ice maker, or a dispenser installed at each side of the refrigerator.

20. The filter assembly of claim 19, wherein the purified water stored in the water tank is supplied via a water outlet pipe in fluid communication with at least one of the first ice maker, the second ice maker, or the dispenser,
wherein the water outlet pipe passes through a portion of the inner casing in contact with the filter casing and is disposed in and extends along a space between the inner casing and an outer casing of the refrigerator,
wherein the water valve is connected to a controller via a connector and is controlled by the controller or receives external power via the connector, and
wherein the connector is connected to the controller or an external power source via an openable or closable portion formed in one side surface of the inner casing.
